(19) United States
(12) Patent Application Publication
(10) Pub. No.: US 2026/0112047 A1
(43) Pub. Date: Apr. 23, 2026

(54) METHOD FOR EXTRACTING AN IMAGE FEATURE FROM AN IMAGE

(71) Applicant: Robert Bosch GmbH, Stuttgart (DE)

(72) Inventors: Fabian Gigengack, Hemmingen (DE); Simon Roesler, Hildesheim (DE)

(21) Appl. No.: 19/350,634

(22) Filed: Oct. 6, 2025

(30) Foreign Application Priority Data
Oct. 21, 2024 (DE) 10 2024 210 137.0

(51) Int. Cl. G06T 7/50; G06V 10/82; G06V 20/58

(52) U.S. Cl. CPC G06T 7/50; G06V 10/82; G06V 20/58; G06T 2207/20084

(57) ABSTRACT

A method for extracting at least one image feature from at least one image generated by at least one real camera, present in a motor vehicle, for monitoring the environment of the motor vehicle. The method includes, in a first step a), the image generated by the camera is transformed into a transformed image by means of a virtual camera which is assigned to the real camera and the optical axis of which extends along a horizontal direction with respect to the motor vehicle, according to which, in a second step b), at least one image feature is extracted from the transformed image.

### CROSS REFERENCE

The present application claims the benefit under 35 U.S.C. § 119 of Germany Patent Application No. DE 10 2024 210 137.0 filed on Oct. 21, 2024, which is expressly incorporated herein by reference in its entirety.

### FIELD

The present invention relates to a method for extracting at least one image feature from at least one image generated by at least one real camera present in a vehicle, in particular in a motor vehicle, for monitoring the environment of the vehicle.

The present invention also relates to a deep learning system that is configured/programmed to perform this method.

The present invention also relates to a vehicle with a control device that is configured/programmed to perform this method.

Furthermore, the present invention relates to a computer program product designed for carrying out the method, in particular by means of the deep learning system.

Furthermore, the present invention comprises a computer-readable data carrier for carrying out the method.

### BACKGROUND INFORMATION

In camera-based image processing of images recorded by a camera present in a motor vehicle, various corrections are often made to the recorded raw image in order to correct imaging errors caused, for example, by distortions in the camera lens. A pixel-by-pixel intensity correction, such as a gamma correction, is also often performed.

The images can then be further processed by means of image processing methods and, alternatively or additionally, subjected to an image analysis and subsequently further processed. In particular, various image features, for example in the form of objects detected in the image, can be extracted from the images and transformed into a 3D space. Preferably, the recorded 2D image can be converted into a 3D image, often by means of a neural network.

If two or more cameras are installed in the vehicle, the extraction of image features and in particular their transformation into a 3D space can require considerable computing power, in particular if a high level of accuracy is to be achieved during the extraction or transformation. This problem becomes more pronounced the more cameras are used to generate images, which can pose significant challenges for a deep learning system or a neural network.

### SUMMARY

It is an object of the present invention to provide an improved method for extracting at least one image feature from at least one image generated by at least one real camera present in a vehicle for monitoring the environment of the vehicle.

This object may be achieved by certain features of the present invention. Preferred example embodiments of the present invention are disclosed herein.

A basic feature of the present invention is to convert the image generated by the real camera into a transformed image by means of a virtual camera before extracting image features or objects from images generated by means of a camera installed on a vehicle, wherein the virtual camera, in contrast to a real camera, is aligned along a horizontal direction with respect to a vehicle coordinate system.

An equivalent approach is to align an optical axis and thus the viewing direction, i.e., the center of the field of view, of the camera parallel to the horizontal. The viewing direction, or the center of the field of view, is therefore arranged parallel to a plane of a 3D bird's eye view. This also means that the virtual camera has a Z-axis that extends along a vertical direction, i.e., perpendicularly to the horizontal or to a horizontal direction.

The vehicle may preferably be a motor vehicle or rail vehicle or mobile robot.

The term “horizontal direction” preferably refers to a horizontal direction of the vehicle or of the roadway traveled by the vehicle at the moment the image is recorded.

According to an example embodiment of the present invention, the image recorded by the real camera at an angle to the horizontal or in a horizontal direction extending along the horizontal is thus converted by means of said virtual camera into a transformed image which would have been created if the real camera had been arranged parallel to the horizontal direction.

The above-described image transformation essential to the present invention simplifies the subsequent extraction of image features from the original image, i.e., in particular the recognition of objects present in the image, and in particular a conversion of the extracted image features into a 3D bird's eye view or into a 3D image space representing this 3D bird's eye view.

This is in particular true if the extraction of the image features from the image recorded by the camera is to be carried out by means of a neural network or by means of a deep learning system comprising such a neural network.

A key reason for the simplifications resulting from the method according to the present invention in the extraction of image features is that all pixels in the same image column in the transformed image have the same XY position and are accordingly arranged at the same distance from the camera in the generated 3D image space.

Conversely, all points in the 3D image space that have the same XY position can be projected onto the same image column of the 3D image space and accordingly have the same (depth) distance from the camera.

For a corresponding inverse transformation of image pixels from the image into the 3D bird's eye view, this means that the 3D position of pixels in a particular image column does not depend on the image row in which the pixel is arranged, but solely on the distance from the camera.

As a result, the procedure explained above creates an improved and greatly simplified method that allows the extraction of image features and, in particular, their conversion into a 3D bird's eye view with increased accuracy.

Following the above inventive features, the method according to the present invention serves to extract at least one image feature from at least one image generated by at least one real optical camera, present in a vehicle, for monitoring the environment of the vehicle. It is understood that two or more cameras of which the optical axes and thus of which the viewing directions differ from one another may be provided in the vehicle.

According to an example embodiment of the method of the present invention, in a first step a), the image generated by the camera is transformed into a transformed image by means of a virtual camera, which is assigned to the real camera and of which the field of view or viewing direction or optical axis extends along a horizontal direction with respect to the motor vehicle. The center of the field of view, i.e., the viewing direction or optical axis of the real camera, typically does not extend along the horizontal direction, but is arranged at an angle thereto.

The transformed image resulting from the originally recorded image by means of the virtual camera, however, corresponds to an image that would have been recorded by a real camera with a horizontal alignment. The term “transformation by means of a virtual camera” refers to an image processing step in which the image is converted into the transformed image as described above.

In a second step b) of the method according to an example embodiment of the present invention, following the first step a), at least one image feature is extracted from the transformed image, preferably by means of a conventional so-called image feature encoder. The encoder may be implemented by software code, i.e., as a computer program product, and executed by the control device that also performs the method according to the present invention.

In the method according to the present invention, the extraction of the at least one image feature according to step b) takes place after the transformation of the recorded image into the transformed image according to step a).

In a preferred embodiment of the method according to the present invention, a camera frustum is generated from the at least one extracted image feature. In this way, a 3D image in which each extracted image feature has 3D coordinates is generated from the transformed 2D image. Due to the preceding transformation, which is essential to the present invention and in which a virtual camera was placed upright, the existing 3D image features can then be transformed into a 3D bird's eye view in a further method step in an extremely simple manner in terms of complexity and thus in terms of the computing power required for this purpose.

The transformation from the 2D image space to the 3D image space can be carried out in the conventional manner, which corresponds to the generation of a camera frustum. Such a camera frustum can preferably be generated by multiplying each 2D image feature by an estimated depth distribution. This generates the voxels that result in the camera frustum.

In an advantageous development of the method according to the present invention, the at least one image feature extracted in step b) is transformed into a 3D bird's eye view in a step c) following step b).

In doing so, the 3D image features of the camera frustum previously calculated in the 3D space are expediently converted into the 3D bird's eye view. For this purpose, the voxels of the camera frustum that have the same BEV coordinates can be aggregated. To this end, voxels with the same BEV coordinates can be sorted and summed, for example in a so-called lift-splat-shoot.

With conventional methods, this procedure is very complex and accordingly requires a lot of computing time and computing power. However, since, in the method according to the present invention, due to the previously performed image transformation of the 2D image by means of a virtual camera according to step a), all image features in the same 3D image column have the same BEV coordinate and differ from one another only by the Z distance, this aggregation is considerably simplified in the method according to the present invention presented here; because the desired 3D bird's eye view can be generated by a simple scalar product/matrix multiplication along the image column axis between the image features and the distance estimates. This eliminates the need for time-consuming sorting and summing of individual voxels, as required in the conventional method.

The aforementioned scalar product/matrix multiplication operation is technically very fast to implement and highly optimized for common ML accelerators.

According to an example embodiment of the present invention, particularly expediently, at least step b) of the method according to the present invention can be performed by a neural network. Such a neural network can in particular be part of a deep learning system. Such neural networks or deep learning systems are used as standard in modern image processing and image analysis systems. The above-described image feature extraction simplification essential to the present invention makes it considerably easier for such a neural network or deep learning system to learn image feature extraction.

In a further preferred example embodiment of the presnt invention, in order to transform the at least one image feature into the 3D bird's eye view in step c), a (depth) distance of the virtual camera from the extracted image feature from the camera can be estimated. This estimation can also preferably be performed by a neural network. Particularly preferably, the estimation of the (depth) distance may also comprise learning of this estimation by the neural network. It proves to be particularly advantageous that the elements or pixels of a specific image column of the transformed image all have the same distance from the camera, in contrast to the original image, i.e., the image that has not yet been transformed by means of the virtual camera.

According to an advantageous development of the present invention, a first and at least a second real camera can be provided in the vehicle. In this development, in step a), each existing real camera is assigned a virtual camera as described above. By means of the method according to the present invention, images from different cameras can thus be converted into 3D images and, in particular, transformed into the 3D bird's eye view.

The advantageous effect of the method according to the present invention is enhanced when two or more cameras are used to generate images, each with a different alignment of the viewing direction or the optical axis.

According to an example embodiment of the present invention, particularly preferably, a Z direction of the virtual camera may extend along a vertical direction perpendicular to the horizontal direction. In this variant, a Z direction of the camera present in the vehicle is arranged at a, preferably acute, angle to the Z direction of the virtual camera.

Accordingly, an optical axis or a viewing direction of the camera extends perpendicularly to the Z direction and thus also perpendicularly to the vertical direction.

The present invention further relates to a deep learning system which comprises at least one neural network, which in turn is configured/programmed to perform the method according to the present invention presented above. The advantages of the method according to the present invention explained above are therefore transferred to the deep learning system according to the present invention.

The present invention further relates to a vehicle, in particular a motor vehicle or a rail vehicle or a mobile robot. The vehicle according to the present invention comprises at least one camera, in particular for monitoring an environment of the vehicle, as well as a control device which interacts with the camera and is configured/programmed to perform the method according to the present invention presented above. The advantages of the method according to the present invention explained above are therefore transferred to the vehicle according to the present invention.

Furthermore, the present invention relates to a computer program product designed for carrying out the method, in particular by means of the deep learning system. The computer program product contains commands that, when the computer program product is executed by the control device of the vehicle and/or by the deep learning system, cause the latter to carry out the method. The advantages of the method according to the present invention explained above are therefore transferred to the computer program product according to the present invention.

The computer program product is preferably stored on a memory comprising at least one non-volatile memory.

The present invention also includes a computer-readable data carrier for carrying out the method. The data carrier comprises commands that, when executed, cause the control device of the vehicle and/or the deep learning system to carry out the method according to the present invention explained above. The advantages of the method according to the present invention explained above are therefore transferred to the data carrier according to the present invention.

Further important features and advantages of the present invention can be found in the disclosure herein.

It is self-evident that the features mentioned above and those still to be explained below can be used not only in the combination specified in each case but also in other combinations or alone, without departing from the scope of the present invention.

Preferred exemplary embodiments of the present invention are illustrated in the figures and are explained in more detail in the following description, wherein the same reference signs refer to identical or similar or functionally identical components.

### BRIEF DESCRIPTION OF EXAMPLE EMBODIMENTS

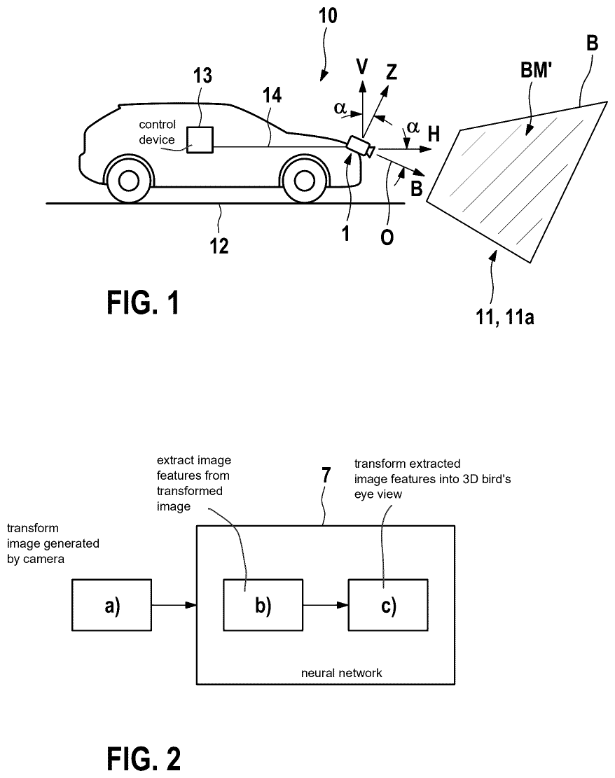

FIG. 1 shows, by way of example, a kind of side view of a vehicle according to the present invention in the form of a motor vehicle with a camera recording an image of the area in front of the motor vehicle,

FIG. 2 is a flowchart illustrating a method according to the present invention by way of example.

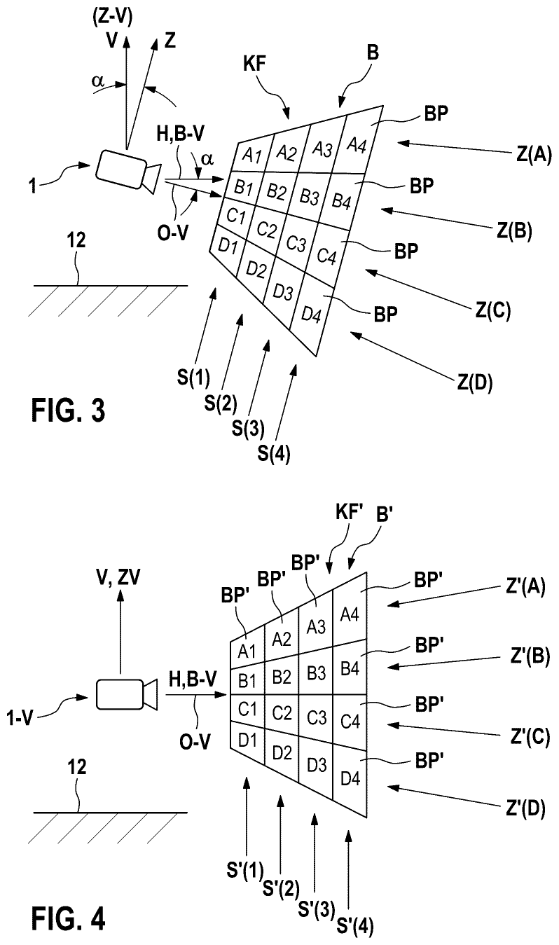

FIG. 3 is a representation illustrating the orientation of the real camera and the orientation of the image recorded by this camera.

FIG. 4 is a representation illustrating the orientation of the virtual camera and the orientation of the image transformed by means of this camera.

### DETAILED DESCRIPTION OF EXAMPLE EMBODIMENTS

FIG. 1 shows an example of a vehicle according to the present invention in the form of a motor vehicle 10 driving on a roadway 12 in a schematic representation and in a kind of side view.

The motor vehicle 10 comprises a camera 1, which monitors an environment 11 or area 11a in front of the motor vehicle 10 and generates images B of this environment 11 or area 11a for this purpose. The camera 1 is also referred to below as the “real camera,” which expresses that it is an actually existing technical device. In contrast, the term of a “virtual camera” 1-V, which does not actually exist, is used below in connection with the method according to the present invention and in particular in connection with the processing of image data.

In the example of FIG. 1, an optical axis O and thus a viewing direction B of the camera 1 is inclined downward, i.e., toward the roadway 12, at an angle α relative to a horizontal direction H.

For clarification, FIG. 3 shows the real camera 1 and the image B in a separate and enlarged view. According to FIGS. 1 and 3, the optical axis O and thus the viewing direction B of the camera 1 extends toward the roadway 12 at an acute angle α to the horizontal direction H. Accordingly, a Z direction Z of the real camera 1 is arranged at the same angle α to a vertical direction V extending orthogonally to the horizontal direction H.

All images B generated by the camera 1 can be transmitted via a communication connection 14, roughly schematically indicated in FIG. 1, to a control device 13 of the motor vehicle 10, which carries out the method according to the present invention during operation.

The method according to the present invention is explained below by way of example using the flowchart according to FIG. 2.

The method serves to extract image features BM′ from the image B (cf. FIG. 1) generated by the real camera 1 for monitoring the environment 11 of the motor vehicle 10.

In the example, the method according to the present invention comprises three steps a), b), and c). In the example, at least steps b) and c) of the method according to the present invention are performed by a neural network 7 (cf. FIG. 2).

According to a first step a), the image B generated by the camera 1 (cf. FIGS. 1 and 3) is transformed into a transformed image B′ (see FIG. 4) by means of a virtual camera 1-V assigned to the real camera 1 and shown in FIG. 4.

In contrast to the real camera 1, the virtual camera 1-V shown in FIG. 4 is oriented such that its optical axis O-V and thus also its viewing direction B-V extends parallel to the horizontal direction H. Accordingly, the Z direction Z-V of the virtual camera 1-V extends exactly along the vertical direction V and thus perpendicularly to the horizontal direction H.

Consequently, the Z direction Z of the real camera 1 present in the motor vehicle 10 is arranged at the acute angle α to the Z direction Z-V of the virtual camera 1-V (cf. FIG. 3).

Referring again to the flowchart of FIG. 2, in a second step b) of the method following the first step a), image features BM', for example in the form of objects, are extracted from the transformed image B′ by means of an image feature encoder. The extraction of image features BM′ according to step b) therefore takes place after the transformation of the recorded image B into the transformed image B′.

Finally, according to the flowchart of FIG. 2, in a third step c) following step b), the image features BM′ extracted in step b) can be transformed into a 3D bird's eye view (not shown).

In order to convert the image features BM′ into the common 3D bird's eye view, a camera frustum KF′ as shown in FIG. 4 can first be generated from the extracted (2D) image features BM′ by converting them into a 3D image space. Each image feature BM′ of the camera frustum KF′ therefore has 3D coordinates. In order to calculate the camera frustum KF′, i.e., the image features BM′ in 3D coordinates, a measured depth distance of the image feature BM′ from the camera 1-V along a Z direction Z-V of the virtual camera 1-V can be estimated by means of the neural network 7.

The advantage achieved by means of the image transformation performed in step a) is explained below with reference to FIGS. 3 and 4, each of which shows a camera frustum with 3D image features.

In contrast to FIG. 4, FIG. 3 shows a camera frustum KF for which method step a) was omitted, and no image transformation was thus performed by means of a virtual camera 1-V. Instead, the camera frustum KF is generated directly from the untransformed image B.

As can be seen in FIGS. 3 and 4, the image B and the transformed image B′ each comprise a plurality of image pixels BP and BP', respectively. Here, each individual image pixel BP or BP′ is assigned to a specific image column S or S′ as well as to a specific image row Z ( ) or Z′ ( ) of the image B or B′.

In the example of FIGS. 3 and 4, the image B and the transformed image B′ each have, purely by way of example and in a highly simplified manner, four image columns S, S′ numbered 1 to 4 and four image rows Z, Z′ numbered A to D. This results in 16 image pixels BP and BP′ with the designation A1 to D4.

The image transformation in the sense of normalization achieved by means of the virtual camera 1-V ensures that the BEV position of a specific image pixel BP′ of the normalized image B', in contrast to the original image B, depends only on its Z distance from the camera 1 or from the virtual camera 1-V and the image column S′ to which the image pixel BP′ belongs. In other words, image pixels BP′ in the same image column S′ of the transformed image B′ occupy the same XY position in the 3D image space at a fixed depth distance from the camera 1.

For example, according to FIG. 4, the four image pixels BP′ designated A3, B3, C3, D3 of column S′=3 in the transformed image B′ have the same measured depth distance along the horizontal direction H from the camera 1 or from the virtual camera 1-V. In contrast, the depth distances of the same four image pixels BP A3, B3, C3, D3 from the camera 1 in the not yet transformed image B are different (cf. FIG. 3).

Similarly to conventional approaches, the depth distance of each image pixel BP′ can also be estimated in the method according to the present invention. In contrast to the estimation of a Euclidean 3D distance from the camera 1, the depth distance of the particular image pixel BP′ from the camera 1 in the image B′ can be estimated due to the transformation or normalization carried out, which is particularly easy to accomplish and to learn for a neural network 7.

For the estimation of the depth distribution itself, various conventional implementations are possible, such as temporal multiview stereo, depth from mono, and lidar-based estimations.

For the transformation of the image features BM′ into the 3D bird's eye view, the camera frustum KF′ can be determined by multiplying each transformed image pixel BP′ with the corresponding estimated depth distribution. Subsequently, it is determined which voxels generated in this way have the same BEV coordinate in the camera frustum KF′. These voxels can be aggregated by simply summing them.

Since the camera frustum KF′ of the virtual camera 1-V is normalized, the individual image rows Z′ in the camera frustum KF′ correspond to the image rows in the BEV representation. The sort order is therefore already given naturally as a result of the normalization of the transformed image B′. Due to this alignment, entire image columns S′ at a certain depth distance can be accumulated, for example summed, and contribute to the same BEV cell, which is given by the horizontal position of the image column S′ in the image B′ and by its depth. A scalar product or matrix multiplication between the depth distribution and the image columns S directly results in the desired 3D bird's eye view in polar representation. This makes the explicit calculation of the BEV target position unnecessary.

Said matrix multiplication is very fast in terms of the required computing time and is highly optimized, in particular for common embedded ML accelerators. In particular, this operation did not require the camera frustum, which is difficult to determine, to be created, stored, or sorted.

A conversion of BEV in the polar space into a regular BEV grid can be realized, for example, by bilinear resampling or forward scattering. This process can be implemented efficiently by means of lookup tables.

Not only the image pixels BP′ but also the image features BM′ generated by means of the feature encoder are features contained in the normalized 3D image space. Since the image B recorded by the real camera 1 was transformed into the normalized image B′ by means of the virtual camera 1, the image features BM′ contained in the transformed image B′ also have the same properties with respect to the XY position and the distance Z as the image pixels BP′ of the transformed image B′. As explained above, image features in the same column S′ have the same XY BEV position and only differ if they have a different Z distance.

In a further variant of the method according to the present invention not shown in the figures, not only a single but two or more real cameras 1 can be provided in the motor vehicle 10. Then, in step a), each existing real camera 1 is also assigned a virtual camera 1-V normalized with respect to the horizontal direction H.

What is claimed is:

1. A method for extracting at least one image feature from at least one image generated by at least one real camera present in a vehicle for monitoring an environment of the vehicle, the method comprising the following steps:
in a first step a), transforming the image generated by the real camera into a transformed image using a virtual camera which is assigned to the real camera and an optical axis of which extends along a horizontal direction with respect to the vehicle; and
in a second step b), extracting at least one image feature from the transformed image, using an image feature encoder.

2. The method according to claim 1, further comprising:
generating, from the at least one extracted image feature, a camera frustum, in which each extracted image feature has 3D coordinates.

3. The method according to claim 1, further comprising:
in a step c following step b), transformng the at least one image feature extracted in step b) into a 3D bird's eye view.

4. The method according to claim 1, wherein at least step b) is performed using a neural network.

5. The method according to claim 3, wherein, in order to transform the at least one image feature into the 3D bird's eye view in step c), a depth distance of the image feature from the camera is estimated, using a neural network.

6. The method according to claim 5, wherein the estimating of the depth distance includes learning the estimation by the neural network.

7. The method according to claim 1, wherein a first and at least a second real camera are present in the vehicle, and, in step a), a respective virtual camera is assigned to each existing real camera.

8. The method according to claim 1, wherein the extraction of the at least one image feature according to step b) takes place after the transformation of the recorded image into the transformed image according to step a).

9. The method according to claim 1, wherein a Z direction of the virtual camera extends along a vertical direction perpendicular to the horizontal direction, a Z direction of the camera present in the vehicle s arranged at an angle to the Z direction of the virtual camera.

10. A deep learning system, comprising:
at least one neural network configured/programmed to perform a method for extracting at least one image feature from at least one image generated by at least one real camera present in a vehicle for monitoring an environment of the vehicle, the method comprising the following steps:
in a first step a), transforming the image generated by the real camera into a transformed image using a virtual camera which is assigned to the real camera and an optical axis of which extends along a horizontal direction with respect to the vehicle, and
in a second step b), extracting at least one image feature from the transformed image, using an image feature encoder.

11. A vehicle, including a motor vehicle or rail vehicle or mobile robot, comprising:
at least one camera configured to monitor an environment of the vehicle; and
a control device which interacts with the camera and is configured to perform a method for extracting at least one image feature from at least one image generated by at least one real camera present in a vehicle for monitoring an environment of the vehicle, the method comprising the following steps:
in a first step a), transforming the image generated by the real camera into a transformed image using a virtual camera which is assigned to the real camera and an optical axis of which extends along a horizontal direction with respect to the vehicle, and
in a second step b), extracting at least one image feature from the transformed image, using an image feature encoder.

12. A data carrier containing commands that, when executed by a vehicle and/or by a deep learning system, cause the vehicle or deep learning system to perforom a method for extracting at least one image feature from at least one image generated by at least one real camera present in the vehicle for monitoring an environment of the vehicle, the method comprising the following steps:
in a first step a), transforming the image generated by the real camera into a transformed image using a virtual camera which is assigned to the real camera and an optical axis of which extends along a horizontal direction with respect to the vehicle; and
in a second step b), extracting at least one image feature from the transformed image, using an image feature encoder.
